(19) United States
(12) Patent Application Publication
(10) Pub. No.: US 2025/0172658 A1
(43) Pub. Date: May 29, 2025

(54) RADAR SYSTEM WITH SPATIAL FILTERING FUNCTIONALITY, MOTOR VEHICLE AND METHOD FOR OPERATING THE RADAR SYSTEM

(71) Applicant: Continental Automotive Technologies GmbH, Hannover (DE)

(72) Inventors: Burak Sahinbas, Regensburg (DE); Mario Schuehler, Effeltrich (DE); Lars Weisgerber, Regensburg (DE)

(21) Appl. No.: 18/954,994

(22) Filed: Nov. 21, 2024

(30) Foreign Application Priority Data
Nov. 27, 2023 (DE) 10 2023 211 796.7

(51) Int. Cl. G01S 7/292; G01S 7/282; G01S 13/02; G01S 13/42; G01S 13/931

(52) U.S. Cl. CPC G01S 7/2923; G01S 7/282; G01S 13/0209; G01S 13/428; G01S 13/931

(57) ABSTRACT

Disclosed is a method for operating a radar system. In a first transmission sequence a first antenna is operated as a TRX antenna transmitting a first radar pulse and a second antenna is operated as a RX antenna. Between a first sequence and a second sequence the second antenna is connected to the signal source using a switch of a control circuit and in the second sequence the antennas switch roles. A second radar pulse for the second sequence is generated coherent to the first radar pulse of the first sequence. An electronic control circuit combines or compares at least one of the first antenna signal and the second antenna signal from the first sequence with at least one of the third antenna signal and the fourth antenna signal from the second sequence for generating an analysis signal and spatial information of the reflecting object is determined based thereon.

### BRIEF DESCRIPTION OF THE DRAWINGS

In the following, an exemplary implementation is described. The figures show:

FIG. 1 a schematic illustration of a top view of an embodiment of a disclosed motor vehicle;

FIG. 2 a schematic illustration of a radar system comprising an antenna aperture with three antennas;

FIG. 3 a schematic illustration of a first sequence of a radar system comprising an antenna aperture with two antennas that can replace the three-antenna aperture of FIG. 2 without losing angular resolution;

FIG. 4 a schematic illustration of the radar system of FIG. 3 during a second sequence.

FIG. 5 schematic diagrams for illustrating the first and the second sequence;

FIG. 6 a schematic illustration of a radar system comprising an antenna aperture according to the disclosure using one additional antenna (first sequence);

FIG. 7 a schematic illustration of the radar system of FIG. 6 during a second sequence;

FIG. 8 a schematic illustration of the radar system of FIG. 6 during a third sequence;

FIG. 9 a schematic illustration of a radar system comprising an antenna aperture according to the disclosure using three additional antennas;

FIG. 10 a schematic illustration of a radar system comprising a 2D antenna aperture according to the disclosure;

FIG. 11 schematic diagrams for illustrating coherent radar pulses.

### DETAILED DESCRIPTION

The disclosure relates to a method for operating a radar system, the radar system comprising at least one monostatic antenna arrangement (aperture) with a first antenna and a second antenna and comprising a signal source for generating radar pulses (at least a first radar pulse and a second radar pulse). An electronic control circuit provides an estimate of an angle of arrival of reflections of the radar pulse that come from a reflecting object in the surroundings. Another application is a beamforming by delay-and-summing the reflected radar pulses (delay-and-sum beamforming). In each sending sequence, one of the antennas is used as a TRX antenna (TRX—transmit and receive) and the other antenna is used as a RX antenna (RX—receive only).

A monostatic UWB (ultra wide band) radar is a single hardware pulsed radar system where a series of UWB pulse signals is transmitted by a TRX antenna that transmits and receives simultaneously. In addition, there exists at least one RX antenna which receive coherently to the transmitter antenna. The coherent transmission and reception of the signals (radar pulses) for an UBW transceiver achieves estimation of the distance of the target or object to the radar antenna, using detected time of arrival (time of flight, ToF) of the respective pulse. This use case is the fundamental application of the UWB radar, where only a single antenna is sufficient. On the other side, the UWB radar is also capable of angle of arrival (AoA) estimation of the targets/objects, using multiple antennas that it occupies in an aperture, i.e. in a fixed geometric setup, also called antenna arrangement in this disclosure. Therefore, combining AoA and ToF using a UWB monostatic radar has the capability of direct localization of the targets.

The total physical space occupied by all the antennas of a monostatic UWB radar is the total aperture size of the hardware. The size of the total aperture is directly proportional to the AoA accuracy (angular resolution) and more importantly, the resolution of the radar, since AoA estimation requires spatial data collection. The antennas are typically spread in a compact space in an equidistant linear array convention. A typical aperture size is in the range of 5 cm to 30 cm (diameter). For UWB linear array (as explained later), the antenna separation can be in the range of 1.5 cm to 2.5 cm (ideally, maximum separation is half the carrier frequency's wavelength). This can be for UWB in the range of 1.7 cm to 1.9 cm, e.g. 1.8 cm. If one considers a practical situation in a motor vehicle, one can think about a size of 4 antenna element array for instance, therefore it is sound to state that array will take less than 10 cm spacing. Therefore, for a better spatial resolution, we require more antennas in such arrays for AoA estimation of the targets. In the automotive industry for instance, such radar systems are used including but not limited to detection and localization of objects as well as human, zone-based gesture recognition, occupant detection and child presence detection. Such applications require high resolution localization, therefore larger antenna aperture size is favored. The aperture size, on the other hand, is limited due to multiple reasons.

First reason is the constraint on the size of the hardware for compact applications needs to be considered. For instance, for a localization system considering inside of the passenger car cabin, there exists significant size constraints on any antenna that could be placed. This forces that number of antennas for the UWB radar must be kept minimal. Second reason is, each antenna requires a full RF chain for baseband signal processing. This increases the unit cost and additional requirements on the PCB (printed circuit board) such as new transmission lines and RF (radio frequency) components must be placed. Third reason is, the UWB chip vendors consider limited number of coherent ports for the antennas, since the main use case for UWB radar is to detect the ToF.

The UWB chips on the other side, provide the capability of switching the TX port without any cost on the hardware. This is known for implementing MIMO systems (MIMO—multiple input, multiple output). In a MIMO system, the switching of the TX port is used to combine sub-groups of different antennas for separate measurements.

An application similar to AoA estimation is beamforming where a combination of the antenna signals from different antennas provides spatial filtering. This is also called delay-and-sum beamforming. Beamforming can be implemented in different, well know ways, for example in time domain or frequency domain.

It is objective of the present disclosure to provide a radar system with a compact antenna aperture and at the same time sufficient spatial resolution for spatial analysis, e.g. AoA estimation and/or beamforming.

The disclosure provides a method for operating a radar system, the radar system comprising at least one monostatic aperture with at least a first antenna and a second antenna. A monostatic aperture is a hardware setup of several antennas with fixed geometric relation as it can be implemented based on a PCB (printed circuit board) carrying the antennas.

The radar system also comprises a signal source for generating radar pulses and an electronic control circuit. The electronic control circuit can be based on a chip or a chipset for processing antenna signals, e.g. in the baseband.

The method comprises the following steps of performing the transmission of radar pulses in at least two successive transceiving sequences. The term “sequence” simply refers to one measurement cycle of transmitting a radar pulse and receiving the reflection/reflections of that radar pulse.

In a first sequence the following steps are comprised:
operating the first antenna as a TRX antenna that is connected to the signal source for transmitting a first radar pulse of the signal source into surroundings of the radar system and that then receives a first reflected radar pulse impinging on the aperture from an external object. It is assumed that the first radar pulse is reflected by an object (target) after transmission into the surroundings. The first antenna generates a first antenna signal from the first reflected radar pulse (reflected by the object in the surroundings).
operating the second antenna as a RX antenna that also receives the first reflected radar pulse and that generates a second antenna signal from the received first reflected radar pulse.

This corresponds to the well-known operation of a radar system with a monostatic antenna aperture (i.e. geometrically fixed antenna arrangement) comprising at least the two antennas.

For obtaining an improved spatial resolution with the same aperture the method characterized by a switching step between the first sequence and a second sequence, wherein by the switching step a switch of the control circuit connects the second antenna to the signal source (and the first antenna is disconnected).

The second sequence then comprises:
operating the second antenna as the TRX antenna that transmits a second radar pulse of the signal source and that receives a second reflected radar pulse impinging on the aperture from the object and that generates a third antenna signal from the received second reflected radar pulse (also reflected by the object in the surroundings),
operating the first antenna as the RX antenna that also receives the second reflected radar pulse and that generates a fourth antenna signal from the received second reflected radar pulse.

The method uses the reflected radar pulses in a novel way in that by the electronic control circuit the following steps are performed (e.g. in baseband):
combining and/or comparing at least one of the first antenna signal and/or the second antenna signal from the first sequence with at least one of the third antenna signal and/or the fourth antenna signal from the second sequence for generating a analysis signal and
detecting a “spatial information” of the object with regard to the aperture from the analysis signal and/or detecting a coherence information regarding the first radar pulse (19) and the second radar pulse (19) from the analysis signal.

The “analysis signal” can be, e.g., a correlation signal or a sum of the antenna signals or a beamforming signal, just to name examples, or a comparison of phase values regarding the phase of the respective reflected radar pulse at the receiving antenna with respect to the carrier signal and/or with respect to the transmitted radar pulse that it originates from. The phase value ϕ can be interpreted as a representation of the time of flight (ToF) of the radar pulse from transmission to reception, wherein ϕ=2πf_{c} T with f_{c} the carrier frequency value and T the time value of the ToF. A difference of phase values of two antenna signals can be determined by, e.g., explicitly calculating their phase values and calculating the difference or by applying a correlation function to the antennal signals. Note that such phase values can also be determined in the baseband, as radar systems use complex valued signals for down-mixing the reflected radar pulse from the carrier frequency into the base band which preserves the phase value (providing in-phase and quadrature components).

The “spatial information” can be, e.g., an estimate of the angle of arrival, AoA or direction of arrival, DoA, in the 2D case (described further below). In general, the actual algorithm for combining/comparing the antenna signals and for detecting the spatial information may be an existing one. The idea concerns a method for providing more antenna signals for that algorithm than there are antennas in the aperture. To this end, the antenna signals from both sequences are compared and/or combined in the same way as the antenna signals of a single sequence from a monostatic aperture with one more antenna. The disclosure thus provides the benefit that two antennas of the aperture can be used for providing three antenna signals that are equivalent of a larger three-antenna aperture. Any algorithm that requires at least these three antenna signals (e.g. antenna signals from an equidistant linear three-antenna array or sub-array) for, e.g., AoA estimation and/or beamforming may be operated on the basis of the first antenna signal together with the fourth antenna signal and one of the second or the third antenna signal.

In other words, the port switching of the TX port is used for the present idea, by creation of synthetic aperture via TRX port switching. Considering the limitations on the number of antennas and the total aperture size, providing the antenna aperture without increasing the number of antennas is a benefit. Therefore, this disclosure considers a synthetic aperture design using a monostatic UWB radar, deployed with a TRX switching scheme with multiple antennas.

The second radar pulse is preferably generated coherent to the first radar pulse. Generation of coherent radar signals or radar pulses is generally known. An alternative way of making an antenna signal from the first sequence comparable and/or combinable with an antenna signal from the second sequence is provided by one aspect of the disclosure.

To this end, said “coherence information” can be, e.g., an estimate of a difference of the phase values of the second antenna signal and the third antenna signal due to a coherence imperfection (e.g. phase drift of signal source due to imperfect oscillator/clock) or non-coherence of the signal source in between the first and second sequence.

When we transmit using antenna 1 (first antenna) and receive using antenna 1 and antenna 2 (second antenna), we have two received signals (CIRs—channel impulse responses) in sequence 1 (S1). Let us call these signals TRX1 (from first antenna) and RX2 (from second antenna). When we change the TRX port (signal source connected to the second antenna in switching step) and we transmit using the antenna 2, and receive using antenna 1 and second antenna 2, we again have two received signals (CIRs) in sequence 2 (S2). Let us call these signals RX1 (from first antenna) and TRX2 (from second antenna). From theoretical point of view, RX2 signal (third antenna signal) and RX1 signal (second antenna signal) are physically “reciprocal”, which means that they must yield equal signals and therefore equal phase difference values with regard to the respective transmitted radar pulse that they originate from, in the case that the first radar pulse and the second radar pulse are generated using a coherent signal source. This coherent radar pulse generation is well known and is also explained below. A calibration mechanism according to the disclosure checks, if we see a different phase on these signals (“coherence information”), this is the phase drift to be corrected (if there is non-coherent case due to clock or some other reasoning). This idea is also regarded as an aspect on its own, in a sense that if between S1 and S2 there exists no coherence at all by the hardware design, we can “create” a coherence by using this reciprocity information (coherence information) and in particular thanks to a short duration between S1 and S2 (less than 200 ms is explained further below). Therefore, it is a complete method for synchronization of sequences if there is no coherence established from the hardware, or a check mechanism for the synchronization of S1 and S2, if there exists clock drifts (imperfect synchronization) or not. Then, after having the coherence either way (generating coherent radar pulses by hardware or using the described calibration method), the creation of the virtual aperture setup and/or the detection of spatial information using signals a) TRX1 (first antenna signal), b) RX2 (second antenna signal) or RX1 (third antenna signal) as they are equal (let's say reciprocal, after calibration) and c) TRX2 (fourth antenna signal).

It is noted that the described operation is fundamentally different from the described MIMO system, as by the method according to this disclosure both sequences are performed using the same antennas.

For continuous surveillance of the target/surroundings, a cyclic repetition of the measurement cycle comprising the two sequences can be performed. This allows for, e.g., tracking the object with regard to its spatial relation to the radar signal, i.e. relative position at least with regard to azimuth and/or elevation. Note that the distance of the object can also be determined from the reflected radar pulses. It is also possible to detect/observe several objects by receiving more than one reflected radar pulse. This can be achieved by applying known algorithms. The method presented here provides the necessary antenna signals on the basis of the two or more than two sequences. The resulting antenna signals can be used in the same manner as in the case of an aperture with more antennas where the antennal signals are generated by one single sequence.

The disclosure also contemplates further developments with technical features that afford further benefits.

A further benefit is obtained when detecting the spatial information comprises generating a beamforming signal (as the analysis signal) by delay-and-summing the first antenna signal and/or the second antenna signal from the first sequence with the third antenna signals and/or the fourth antenna signal from the second sequence. A similar benefit is also obtained when detecting the spatial information comprises determining (as the analysis signal) a first phase difference of one of the antenna signals of the first sequence and one of the antenna signals of the second sequence and determining an angle value from the first phase difference value, the angel value signaling an angle of arrival of the reflected radar pulses that are impinging from the object that reflects the transmitted radar pulses, using geometric data describing a relative geometric arrangement of the first antenna and the second antenna. This assumes that reflected radar impulses taken into account come from the same object. Using at least the first antenna signal and the fourth antenna signal corresponds to providing an aperture with one more antenna than the given real antennas of the radar system. In other words, this use case simulates a virtual additional antenna for spatial analysis of the reflected radar signal. Note that selecting the correct reflected radar pulse in the case of several objects that each reflect the transmitted radar pulse of the current sequence is known.

Additionally, using at least the second antenna signal and the third antenna signal allows to re-synchronize the antenna signals from the two sequences in the case of, e.g., clock jitter or missing coherence during the generation of the two transmitted radar pulses.

Accordingly, a further benefit is obtained by calibrating the coherence of the signal source by:
determining a second phase difference value of a phase difference of one of the antenna signals of the first sequence and one of the antenna signals of the second sequence, wherein preferably the second antenna signal and the third antenna signal are used, e.g. a phase difference value indicating the difference in the phase values of these antenna signals; and
determining a phase drift value of a phase drift that the signal source exhibits between the first radar pulse and the second radar pulse, wherein the phase drift value is calculated from a difference between the second phase difference value and a predefined reference value, preferably 0; and
determining a correction value for compensating the phase drift, wherein the correction value is chosen such that considering the correction value yields a second phase difference value equal to the reference value.

The correction value can be advantageously used, e.g., to set or adapt a starting time for generating or transmitting the second radar pulse in a following measurement cycle comprising the next first sequence and second sequence such that the first and the second radar pulse are coherent despite the presence of the phase drift. Additionally or alternatively, the correction value may be applied during the AoA estimation and/or beamforming for shifting or correcting the phase of at least one of the antenna signals. For example, the phase difference value can be the difference ϕ_{A} or absolute value of the difference ϕ_{A} of the phase values ϕ₂ of the second antenna signal and the phase value ϕ₃ of the third antenna signal, ϕ_{Δ}=|ϕ₂−ϕ₃|. In this case, the phase difference value can also be interpreted as the phase shift value, if the two transmitted radar pulsed started with identical starting phase of the sinus carrier wave, when the respective radar pulse was started (e.g. with phase 2πn, with n an integer number, i.e. when the sinus carrier wave is zero). In this case, the reference value can be 0, as no phase difference should exist. The correction value can then be defined the negative value of the phase shift value (for compensating or un-doing the phase shift value, in order to obtain 0 phase difference). Otherwise, a (deliberate) difference in starting phase of the carrier wave for the two radar pulses can be used as the reference value, such that the correction value, when applied, preserves this deliberate difference in starting phases.

A further benefit is obtained when the determining of the first phase difference value comprises that a time difference and/or a phase value difference of those antenna signals that are used for determining the first phase difference is evaluated. The generation of the first phase difference value can be implemented, e.g. by correlating the two antenna signals in time domain and/or by spectral analysis of their phases (using, e.g. a complex Fourier transform). Likewise the generation of the second phase difference value can be implemented.

A further benefit is obtained when a time difference between first sequence and second sequence less than 200 ms, at least less than 500 ms. This prevents a potential incompatibility of the antenna signals from the first and second sequence in the case of a relative movement of the object with regard to the aperture that might result in different angles of arrival of the reflected radar pulses due to a change in position.

Within the above-mentioned time interval the change in angle of arrival is small enough (for relative velocities below 200 km/h and distances lager than 25 m) such that the change in angle of arrival is below the measurement accuracy of the radar system anyway.

A further benefit is obtained when the coherency of the signal source is established by using a single common clock and/or oscillator for generating the first radar pulse and the second radar pulse and/or by generating the first radar pulse and the second radar pulse as signals that start with identical phases. This results in less hardware requirement for getting coherency. Other known methods may also be used.

A further benefit is obtained when the respective antenna signal is provided as a channel impulse response, CIR. The CIR can advantageously be processed in the baseband by the electronic control circuit.

A further benefit is obtained when the respective radar pulse is generated using an ultra-wide band (UWB) signal for generating the pulse or pulse envelope. The bandwidth of the UWB signal can be in the range of 200 MHz to 800 MHz, e.g. 500 MHz (in baseband). The carrier frequency of the radar transmission can be in the range of 5 GHz to 8 GHz, e.g. 6.5 GHz. Using a coherent UWB radar system generates a beneficial temporally narrow radar pulse such that different objects can be distinguished using the two sequences, because the reflected radar pulsed are unlikely to overlap if they are at different distances to the antenna aperture.

A further benefit is obtained when at least one additional antenna is provided (i.e. three or more antennas overall) and for each additional antenna an additional sequence is performed in which the respective additional antenna is operated as the TRX antenna and from each additional sequence at least one additional antenna signal is determined that is used for determining the angle value and/or for beamforming. With each additional antenna, the angular resolution can be increased as noise and/or ambiguities can be resolved.

A further benefit is obtained when the first antenna, the second antenna and each additional antenna are arranged in a linear antenna arrangement, preferably an equidistant linear antenna arrangement. In this arrangement the distance of the “virtual antenna” from the aperture (as it results from combining the antenna signals of two or more sequences) is maximized and thus the improvement in angular resolution is highest.

Alternatively, a further benefit is obtained when the first antenna, the second antenna and each addition antenna are arranged in a 2D or 3D antenna arrangement (i.e. 2D: not in one straight line; 3D: not in a planar arrangement) and the respective “spatial information” is calculated based on vector calculation using distance vectors each describing the relative geometric arrangement of two of the antennas in 2D or 3D space. This type of arrangement can resolve ambiguities in azimuth angle and/or elevation angle.

For use cases or use situations which may arise in the method and which are not explicitly described here, it may be provided that, in accordance with the method, an error message and/or a prompt for user feedback is output and/or a default settings and/or a predetermined initial state is set.

One further solution to the above stated underlying technical problem is provided by a radar system comprising an antenna aperture with at least a first antenna and a second antenna and comprising a signal source for generating radar pulses and comprising an electronic control circuit that is configured to determine a comparison using angle of arrival estimation and/or beamforming from reflected radar pulses received by the antennas, wherein the signal source is connected to the a first antenna and a second antenna over a switch for selectively or alternatingly connecting the signal source to at least the first antenna and the second antenna, and wherein the radar system is configured to perform the steps of any one of the described methods.

Such a radar system can advantageously be operated in a motor vehicle with only little or limited space.

Accordingly, the disclosure also contemplates a motor vehicle comprising at least one radar system that is an embodiment of the disclosed radar system. The motor vehicle can be a road vehicle, in particular a passenger vehicle or a truck or a motor bike, just to name examples.

A further benefit is obtained when the at least one radar system is connected to a control device of the vehicle, wherein the control device is configured to
determine a relative position of another traffic object in surrounding traffic by using an angle of arrival determined by the at least one radar system,
distinguish between two traffic objects in the surrounding traffic by using at least two angles of arrival determined by the at least one radar system,
detect a position and/or a movement of a body or of a body part of a person next to the vehicle or inside the vehicle, using at least one angle of arrival determined by the at least one radar system,
a presence of a person on a vehicle seat, using at least one angle of arrival determined by the at least one radar system.

These applications profit from an increase in angular resolution based on the described effect of generating a coherent second radar pulse in a second sequence.

The disclosure also contemplates combinations of the features of the described embodiments.

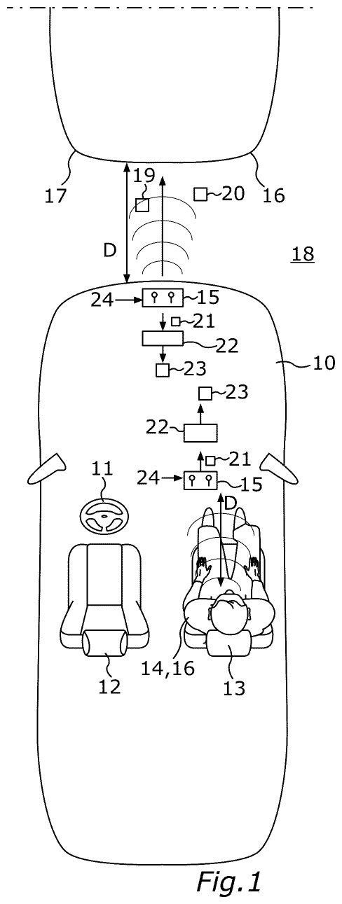

FIG. 1 shows a motor vehicle 10 that can be, for example, a passenger vehicle or a truck. As a visual orientation, a steering wheel 11, a driver seat 12 and a passenger seat 13 are shown. In the passenger seat 13 can be sitting a passenger 14.

The vehicle 10 may comprise one or more radar systems 15 for detecting objects 16. One radar system 15 may have a detection range pointing towards the driver seat 13 for detecting the passenger 14. One radar system 15 may have a detection range directed towards traffic in the surroundings 18 of vehicle 10 for detecting another motor vehicle or in general a traffic participant 17 as an object 16. As illustrated in FIG. 1, the respective object 16 may have a distance D to the respective radar system 15 that is detecting the object 16. For the detection, the radar system 15 may transmit or emit a radar pulse 19 that is reflected by the respective object 16 such that a reflected radar pulse 20 returns to the radar system 15. From the reflected radar pulse 20, the radar system 15 may extract or derive or calculate a spatial information 21, for example an angle of arrival, AoA, of the reflected radar pulse 20 with respect to the radar system 15 that is detecting it. Based on the spatial information 21, a control device 22, for example an electronic control unit, ECU, may provide a functionality 23, for example the detection of the presence of a person like passenger 14 and/or a relative position of a traffic object 16, like the traffic participant 17, with regards to vehicle 10.

The spatial information 21 can be derived with more accuracy, the more antennas an antenna aperture 24 of the radar system 15 comprises.

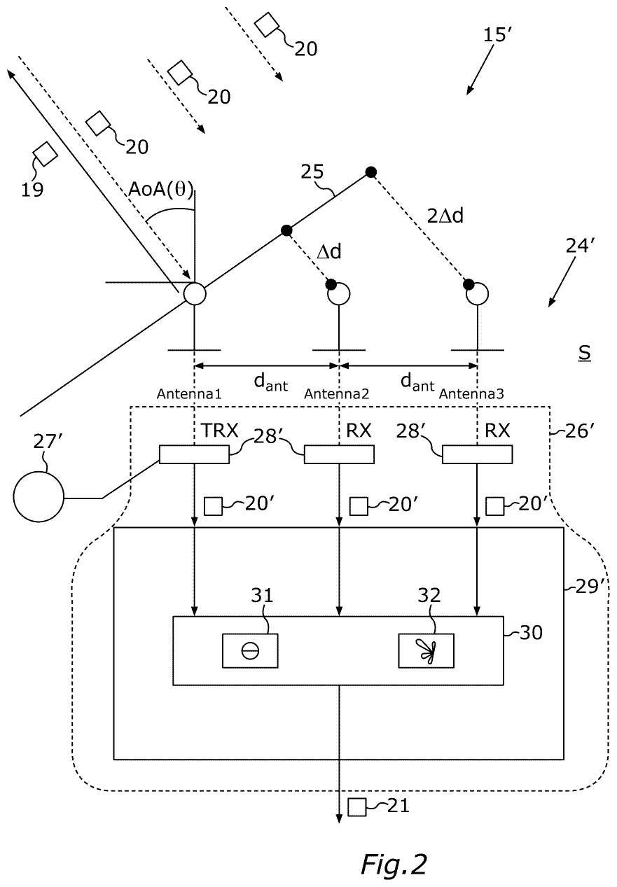

For comparison reasons, FIG. 2 illustrates a radar system 15′ using an aperture 24′ with three antennas, i.e. Antenna1, Antenna2, Antenna3, that are arranged in a linear antenna array (all antennas arranged in a straight line) with equidistant arrangement with distance dₐₙₜ. The spatial information 21 estimated or derived by an electronic control circuit 26′ of the radar system 15′ may be derived using a processor 29′ using a known algorithm 30 for deriving the angle of arrival 31 and/or apply spatial filtering by beamforming 32.

Each antenna may be connected to the processor 29′ via electronic hardware 28′ that may comprise, for example, a radiofrequency front-end (RF front-end) and/or a mixer for up-mixing and/or down-mixing. The radar pulse 19 that is transmitted towards the object 16 may be emitted by one of the antennas (TRX antenna) based on a carrier signal controlled that is controlled or modulated by a pulse signal. The signal may be controlled and/or generated by a signal source 27′. The reflected radar pulse 20 deriving or impinging from a specific object 16 may form a wave front 25 that hits or impinges on the antenna aperture 24′ thus reaching the respective antenna. The respective antenna, Antenna1, Antenna2, Antenna3, receives the reflected radar pulse 20 reflected by the object 16 and generates a corresponding antenna signal 20′ that may be provided to the algorithm 30. The whole process of sending out a radar pulse 19 and receiving and processing the reflected radar pulse 20 is also termed “sequence” S. From the antenna signals 20′ of the antennas, the angle of arrival 31 can be estimated and/or the beamforming 32 can be performed in the well-known manner and the spatial information 21, for example an estimate of the angle of arrival and/or a signal intensity or signal power as a function of detection angle using beamforming, may be provided.

The underlying principle is to estimate the extra propagation distance of the impinging signal (reflected radar pulse) with respect to the receiver antennas provides the relation between the phase difference of the signals received from the antennas and the angle of arrival of the signal. TRX implies that the antenna is transmitting and receiving at the same time, while RX implies that the antenna is receiving only. The system is assumed to be coherently transmitting and receiving.

If FIG. 2 is investigated, it is seen that when the signal is transmitted from a TRX antenna, the round-trip time of the signal when it is reflected from the target gives the distance of the target with respect to the transmitter antenna, as the speed of electromagnetic wave is known. For instance, if the target is at distance D, then the round-trip time

$$τ 1 = ( 2 D ) / c$$

where c is the speed of wave in the medium and is known to us. The multiplier “2” comes from the round-trip of the signal from transmission to reception upon reflection, where it travels the D twice. For the second antenna, if a coherent receiver system is considered, the realized round-trip time

$$τ 2 = ( 2 D + Δ d ) / c$$

is obtained, with the effect of the additional distance Δd. From the geometric relation, the Δd is given by

$$Δ d = ( {d}_{ant} sin ( θ ) )$$

and if the two equations are merged, for the second antenna it is found that

$$τ 2 = ( 2 D ) / c + ( {d}_{ant} sin ( θ ) ) / c$$

is found. Here, it is important that the delay of the second antenna is related to the AoA, due to the presence of the term theta in the phase expression. As indicated, the phase difference is the fundamental parameter of the angle estimation. This delay induced phase can be obtained from baseband signal processing theory, where the signal phase is given by (2πcτ) for an arbitrary delay where fc is the carrier frequency of UWB signal. Therefore, if the complex baseband equivalent signals of the two antennas are taken, the phase difference between the two antennas yields the angle related variable. The phase of antenna 1 is given by

$$Φ 1 = \frac{2 π fc ( 2 D )}{c}$$

and similarly,

$$Φ 2 = \frac{2 π fc ( 2 D )}{c} + \frac{2 π {fcd}_{ant} sin ( θ )}{c}$$

where it is seen that if the antenna 1 is transmitting, by obtaining the detected phases on both antennas, we have the residual term (second term in summation above) above that this gives us the AoA of the impinging signal.

Since the AoA radar system makes use of a phase comparison of distinct antennas in an array, having two antennas implies that it is only possible to resolve 1 impinging signal, if the signal is not separable by other means (time domain gating, different frequency, coding, etc). Besides, even if a single target is considered, the observations are typically significantly noisy and therefore having more independent phase difference data is crucial for increasing the accuracy of the AoA system. Therefore, increased aperture by having more antennas is essential, and as seen in FIG. 2, having a third antenna experiences the delay:

$$τ 3 = ( 2 D + 2 Δ d ) / c$$

as the signal is travelling the extra distance of 2Δd instead of a Δd, which yields the phase given by:

$$Φ 3 = \frac{2 π fc ( 2 D )}{c} + \frac{2 π fc 2 ( {d}_{ant} sin ( θ ) )}{c}$$

where the observation is coming from another antenna and is independent in terms of the noise. Similar pattern follows, if more antennas are used, therefore more information for AoA can be obtained and a better AoA accuracy can be achieved.

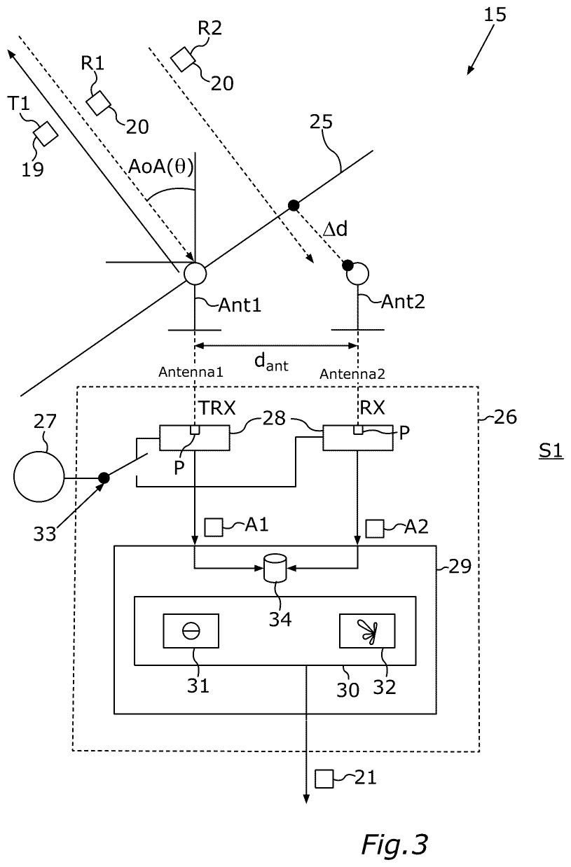

FIG. 3 illustrates a radar system 15 according to the idea disclosed herein. The radar system 15 may provide the spatial information 21 with the same angular resolution and/or accuracy, although not three antennas like in FIG. 2, but one less antenna, i.e. only two antennas Ant1, Ant2 for receiving the reflected radar pulse 20 are used. The distance of the antennas may be chosen as dₐₙₜ, which can be in the range of 0.5 cm to 5 cm.

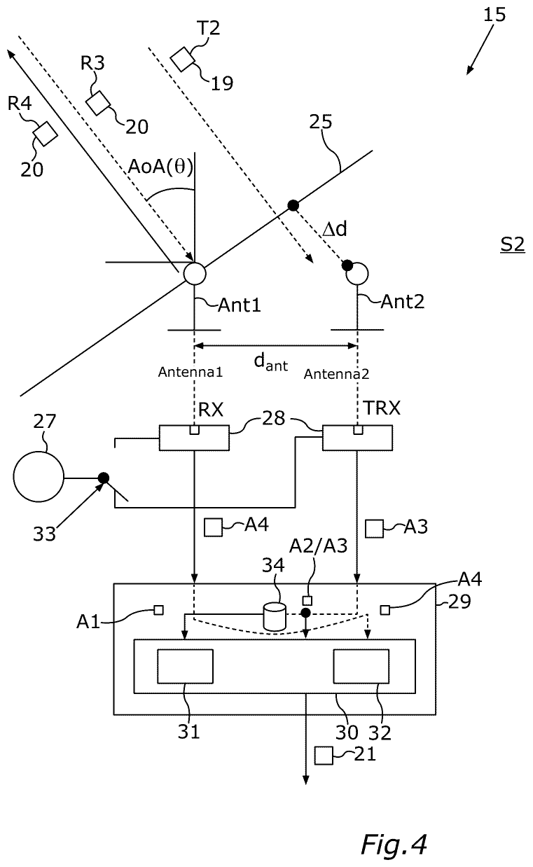

This is achieved by sending out two radar pulses 19 in two consecutive sequences S1 (FIG. 3) and S2 (FIG. 4).

For distinguishing between the transmitted radar pulses 19 of the two sequences S1, S2 they are termed first radar pulse T1 (in sequence S1) and second radar pulse T2 (in sequence S2).

In the first sequence S1, antenna Ant1 transmits the radar pulse 19 as the TRX antenna. The reflected radar pulse 20 reflected from the same object, i.e. the wave front 25, is termed first reflected radar pulse R1 that is received by antenna Ant1 and the second reflected radar pulse R2 that is received by antenna Ant2.

An electronic circuit 26 of radar system 15 may process the received radar pulses 20 in the same manner as it is known, thus resulting in antennae signal A1 from antenna Ant1 and antenna signal A2 from antennae Ant2 is generated. A processor 29 may sample the antenna signals A1, A2 and store them in a data storage 34. The antenna signals may be received at a respective port P of the processor electronic circuit.

The processor 29 may provide the same algorithm 30 as known for estimating the angle of arrival 31 and/or performing beamforming 32, such that the spatial information 21 may be derived based on the same processing steps or calculations of sampled antenna signals.

The radar system 15 may comprise a switch 33 that may selectively or alternatingly connect the signal source 27 of radar system 50 with one of the antennas Ant1, Ant2. In the first sequence S1, the switch 33 may connect the signal source 27 to the first antenna Ant1, only.

FIG. 4 illustrates, how the missing third antenna (as compared to FIG. 2) may be simulated or generated as a virtual antenna by the second sequence S2. Between the first sequence S1 and the second sequence S2, the switch 33 may disconnect antenna Ant1 from the signal source 27 and may connect the signal source 27 to the second antenna Ant2.

Then, the transmitted radar pulse 19 for the second sequence S2, i.e. transmitted radar pulse T2, is emitted by the second antenna Ant2. Thus, antenna Ant2 is operated as the TRX antenna. The received, reflected radar pulses 20 that is received by Ant2 is named reflected radar pulse R3, the reflected radar pulse 20 received by the RX-antenna Ant1 is named reflected radar pulse R4. Thus, the difference between sequence S1 and sequence S2 is that the TRX-antenna is antennae Ant1 in sequence S1 and in sequence S2 it is antenna Ant2. Those two sequences S1, S2 have in common that the same set of antennas are used.

Based on the hardware 28, the antenna signals A3 from antennae Ant2 based on the reflected radar pulse R3, and also from the reflected radar pulse R4, received by antenna Ant1, the antenna signal A4 is generated. The processor 29 may receive the antenna signals A3, A4.

By the processor 29, at least one of the antenna signals A3, A4 from sequence S2 may be combined with at least one of the antenna signal A1, A2, from the sequence S1 taken from the storage 34. The antenna signal A3, A4 may also be stored in storage 34 for recombining three or four of the antenna signals A1 to A4 for example for an adaptive beamforming or a beamforming 32 with a beam directed to different angular directions.

Thus, the algorithm 30 may be provided with three antenna signals that may be used in the same way as in the radar system 15′ for deriving the spatial information 21.

The embodiment shown in FIG. 3 and FIG. 4 can be used as an AoA estimation system that uses a uniform antenna array with minimum size of 2 antennas Ant1, Ant2. There exists a relation between received phases of the signals and the angle of arrival of the signal, which is demonstrated in the following. The principal concept of AoA estimation is to get the phase difference of a wave reaching to distinct elements of the antenna array on a comparative basis.

Simulating the three-antenna array using TRX Switching can be achieved in the following way:

The key idea can be stated as following. Using a coherent UWB radar system, the observation of phases using 3 antennas, which is explained in connection with FIG. 2, can be achieved equivalently using two antennas and changing the TRX antenna.

To perform this, it is needed to make 2 measurement sequences, which are coherent to each other. Considering 2 element array, the sequences can be defined as:

### Sequences 1 (FIG. 3):

UWB pulse is transmitted using antenna 1
Reflected signal is received by antenna 1 and antenna 2

### Sequences 2:

UWB pulse is transmitted using antenna 2
Reflected signal is received by antenna 1 and antenna 2 which is also demonstrated in FIG. 4.

The channel impulse responses (CIRs) are collected during the sequences, where both pulse transmission and reception operations are coherent to each other. It will be considered later in the document, but at this moment, coherency is assumed.

Using the sequence 1 and 2, the phase relation is achieved as follows. For the first sequence, the antenna 1 transmits and receives, therefore the propagation time induced phase for the UWB pulse received by the antenna 1 is:

Thus, Sequence S1 is when the antenna 1 used as TRX and the antenna 2 used as RX (FIG. 3). Sequence S2 is when the antenna 1 used as RX and antenna 2 used as TRX (FIG. 4). Combination of the sequences are used for creation of the synthetic aperture.

$$τ 1 = \frac{2 D}{c}$$

and similarly, the antenna 2 receives the pulse with a propagation time of:

$$τ 2 = \frac{2 D + Δ d}{c}$$

which is identical to τ1 and τ2 as described in FIG. 2. Then, when the TRX is switched and sequence 2 is formed, it is achieved that the antenna 2 transmits, therefore the signal experiences the extra path Δd at the transmission path, and then the pulse received by antenna 1 experiences the propagation time of:

$$τ 3 = \frac{2 D + Δ d}{c}$$

which is identical to τ2. Simultaneously, the antenna 2 receives its own transmitted signal as well, where the signal experiences the extra propagation distance twice. This implies that the antenna 2, which is now TRX, experiences the propagation time of:

$$τ 4 = \frac{2 D + Δ d}{c}$$

as the two pulses used in different sequences are coherent to each other. Therefore, the phases of the received signal using 2 antennas and changing the TRX antenna can be listed as:

$$\begin{matrix}Φ 1 = \frac{2 π fc ( 2 D )}{c} \\ Φ 2 = \frac{2 π fc ( 2 D )}{c} + \frac{2 π {fcd}_{ant} sin ( θ )}{c} \\ Φ 3 = \frac{2 π {f}_{c} ( 2 D )}{c} + \frac{2 π {fcd}_{ant} sin ( θ )}{c} \\ Φ 4 = \frac{2 π fc ( 2 D )}{c} + \frac{2 π fc 2 ( {d}_{ant} sin ( θ ) )}{c}\end{matrix}$$

with fc the carrier frequency, e.g. fc=6.5 GHz.

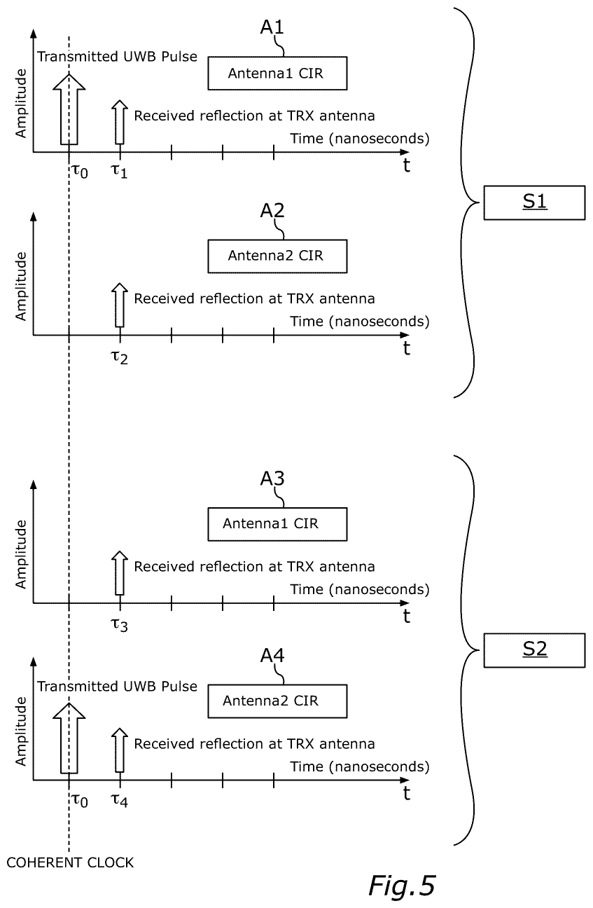

FIG. 5 illustrated the amplitude of the channel impulse responses (CIRs) of the antenna Ant1 and antenna Ant2 where the target is assumed to be at a fixed distance D. The sequences and coherency of the pulses due to having a fixed clock reference at τ₀ are demonstrated.

If the phase relations with 3 antennas and 2 antennas with TRX switching are compared, it is revealed that the identical phase structure is achieved only using 2 antennas, which is called the synthetic aperture, since effectively 2 antennas are realizing a 3-antenna setup. The identical relations are covered by (P2 and (P3.

As indicated while defining the sequences, the coherency of the system is assumed as an essential hypothesis for the creation of the synthetic aperture. Here, the coherency implies 2 facts. The first fact is, the UWB pulses are assumed to be referenced to the identical clock, even if they are realized using a sequentially transmitted pulse using distinct antennas. This is enabled by the state-of-the-art UWB chips.

For the UWB pulses, the coherency is established using a single clock for all the RF chains and therefore, multiple coherent pulses can be transmitted. This enables that without losing clock reference where the phase information is referenced to, a TX antenna can be switched. Then, using the channel impulse response (CIR), the received UWB signal can be obtained with a fine and coherent time reference. This is demonstrated in FIG. 5, where the UWB signal is sliced from time domain and the phase differences coming from the propagation delay experienced by the signal for different paths are obtained.

The second fact regarding the coherency of the switching system is that, during the measurement interval, the above analysis considers that the target is static. In practice, the targets are typically not static, but moving like a walking motion or as a minimally moving case, a breathing can be given as an example. Here, the counter measure for this is that compared to the motion of the target, the switching is significantly faster compared to the motion of the target. Moreover, for the considered TRX switching scheme, it is demonstrated that the system realizes theoretically 2 identical phase responses, the ϕ2 and ϕ3, in different measurement sequences. Using these phases which are expected to overlap, a further calibration is applied to achieve coherency such that the difference between these 2 phases is used to correct the ϕ4 This calibration step makes the system fully coherent and essential in the present idea.

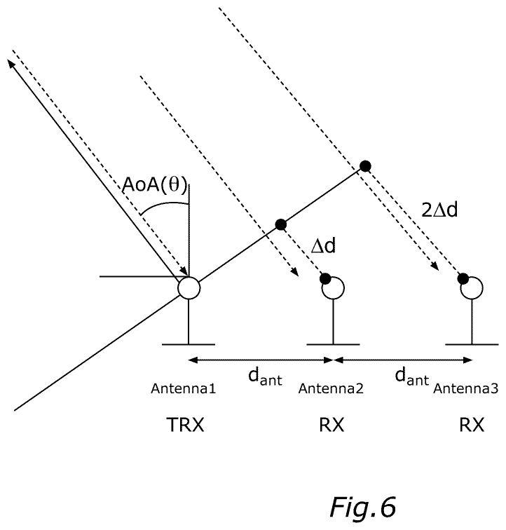

FIG. 6 to FIG. 8 illustrate an extension of the Synthetic Aperture (virtual antenna) to multiple TRX switching steps: The idea of TRX switching and reaching a synthetic antenna aperture can be applied to more antennas. For instance, following the above arguments and derivations, 3 antennas with 2 TRX switching yields the following phases:

FIG. 6 illustrates sequence 1 (Antenna 1 is TRX) resulting in the following phase relations of the reflected radar pulses and the antenna signals, with phase p of antenna 1, antenna 2, antenna 3:

$$ϕ 1 = \frac{2 π fc ( 2 D )}{c} , ϕ 2 = \frac{2 π fc ( 2 D )}{c} + \frac{2 π fc ( {d}_{ant} sin ( θ ) )}{c} , ϕ 3 = \frac{2 π fc ( 2 D )}{c} + \frac{2 π fc 2 ( {d}_{ant} sin ( θ ) )}{c}$$

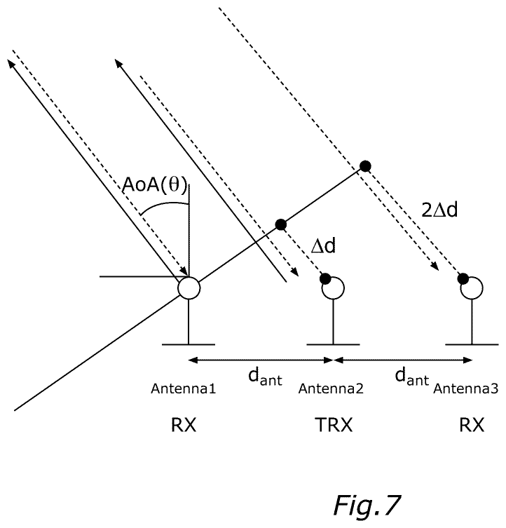

FIG. 7 illustrates sequence 2 (Antenna 2 is TRX) resulting in the following phase relations of the reflected radar pulses and the antenna signals, with phase ϕ of antenna 1, antenna 2, antenna 3:

$$ϕ 3 = \frac{2 π fc ( 2 D )}{c} + \frac{2 π fc ( {d}_{ant} sin ( θ ) )}{c} , ϕ 4 = \frac{2 π fc ( 2 D )}{c} + \frac{2 π fc ( {d}_{ant} sin ( θ ) )}{c} , ϕ 5 = \frac{2 π fc ( 2 D )}{c} + \frac{2 π fc 3 ( {d}_{ant} sin ( θ ) )}{c}$$

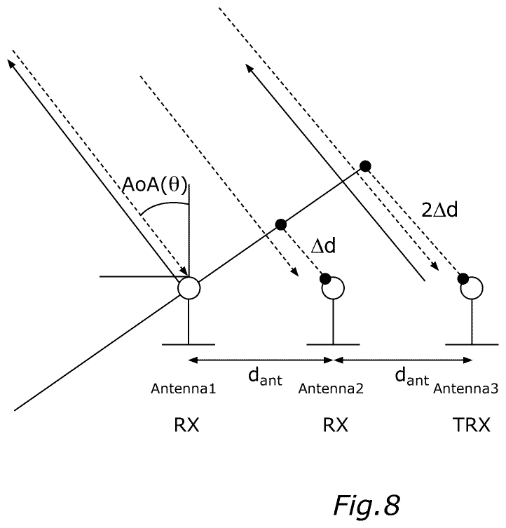

FIG. 8 illustrates sequence 3 (Antenna 3 is TRX) resulting in the following phase relations of the reflected radar pulses and the antenna signals, with phase ϕ of antenna 1, antenna 2, antenna 3:

$$ϕ 3 = \frac{2 π fc ( 2 D )}{c} + \frac{2 π fc ( {d}_{ant} sin ( θ ) )}{c} , ϕ 4 = \frac{2 π fc ( 2 D )}{c} + \frac{2 π fc ( {d}_{ant} sin ( θ ) )}{c} , ϕ 5 = \frac{2 π fc ( 2 D )}{c} + \frac{2 π fc 4 ( {d}_{ant} sin ( θ ) )}{c}$$

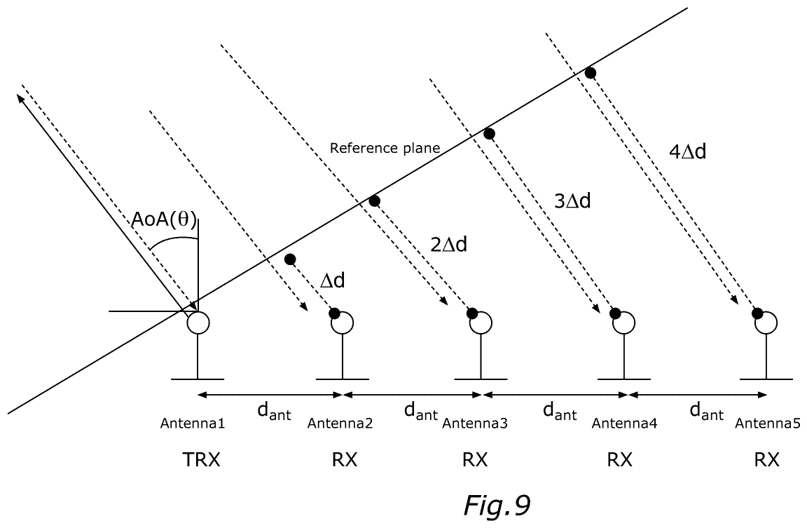

with ϕ₃ the phase of antenna 1, ϕ_4 the phase of antenna 2, ϕ_5 the phase of antenna 3. If coherency is provided using the aliasing phases and the defined calibration technique, effective antenna aperture is 5 element uniform antenna array. The equivalent array without switching the TRX would be a 5 element antenna array illustrated in FIG. 9.

The predictable effects on the limitation for increasing the synthetic aperture can be summarized as the effectiveness of the calibration technique (more switching steps imply more observation time elapsed and therefore making it difficult to calibrate), the instantaneous velocity of the target as well as the angular spread of the multi-path components coming from the radio channel. For a static target, the aperture is increased by amount of number of TRX switches.

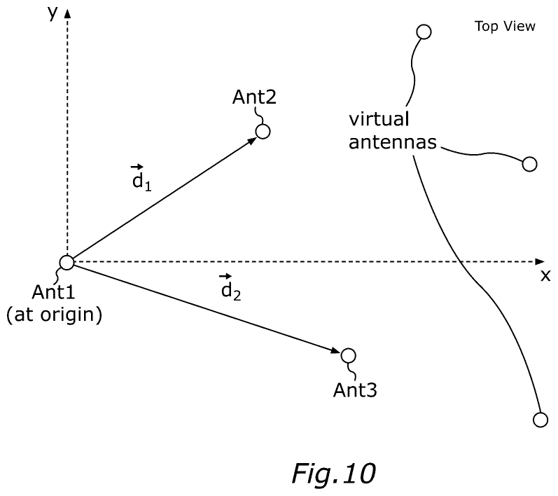

FIG. 10 illustrates a 2D antenna arrangement. The synthetic aperture concept further expands to 2D antenna arrangement. So far, the explanations for 1D (linear antenna array) demonstrated that the key fact is additional propagation of the wave during its coherent transmission, reflection from the target and reception. Therefore, a similar phase relation can be observed if a 2D antenna constellation is considered. The placement of the antennas is not limited to a linear structure with equidistant pattern, but in fact arbitrary.

The generic direction of arrival (DoA) of a signal is an AoA estimation in azimuth and elevation planes, which is represented by a unit vector:

$$\begin{matrix}\vec{k} = ( \frac{2 π {f}_{c}}{c} ) ( {k}_{x} \vec{{a}_{x}} + {k}_{y} \vec{{a}_{y}} + {k}_{z} \vec{{a}_{z}} ) \\ \vec{k} = ( \frac{2 π {f}_{c}}{c} ) ( {k}_{x} \vec{{a}_{x}} + {k}_{y} \vec{{a}_{y}} + {k}_{z} \vec{{a}_{z}} )\end{matrix}$$

where the \vec{aₓ}, \vec{a_{y}}, \vec{a_{z}} are the unit vectors in x, y, and z axes. For an arbitrary shape, the additional phase induced by the additional propagation of the wave with respect to the reference antenna (anti) is given by (ϕ2−ϕ1)=\vec{k}·\vec{d₁}, where the dot symbol is the dot product. Similarly, any combination of the vectors yields the DoA and synthetic aperture related phase with respect to the reference element.

As an example, the following antenna constellation can be used: For this case the reference antenna is antenna 1. Considering a coherent system and following the identical reasoning for the 1D case, the additional phase differences which synthesize the aperture can be summarized in the following table:

| | ANT1 RX phase | ANT2 RX phase | ANT3 RX phase |
|---|---|---|---|
| ANT 1 TX | 0 | \vec{k} · \vec{d₁} | \vec{k} · \vec{d₂} |
| ANT 2 TX | \vec{k} · \vec{d₁} | 2(\vec{k} · \vec{d₁}) | \vec{k} · (\vec{d₁} + \vec{d₂}) |
| ANT 3 TX | \vec{k} · \vec{d₂} | \vec{k} · (\vec{d₁} + \vec{d₂}) | 2(\vec{k} · \vec{d₂}) |

Using three antennas (ANT1, ANT2, ANT3) and two Tx switching, equivalently a 5-antenna aperture can be obtained, which follows exactly the same arguments for 1D case. If the table is observed, the equivalent signal there exists aliasing phase again for calibration. As a result, a 2D synthetic aperture is possible, providing coherent transmission and the TX switching.

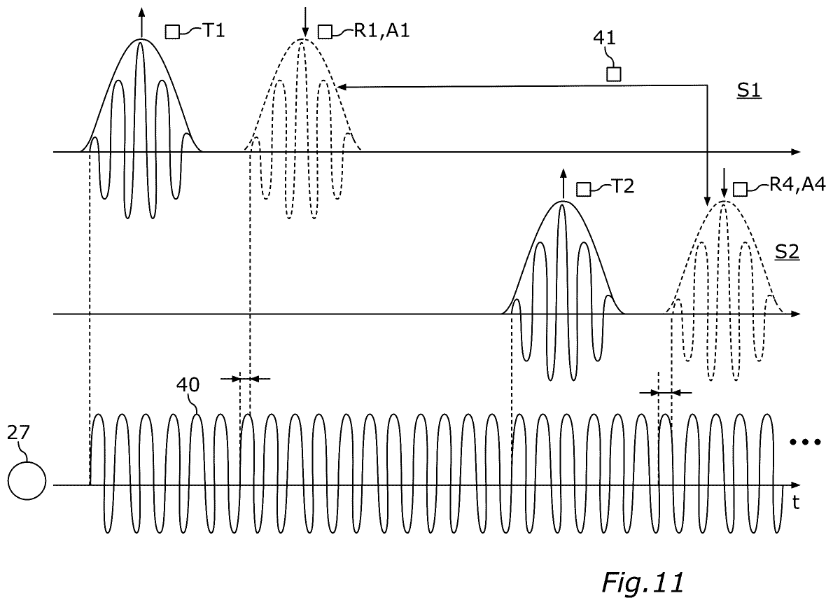

FIG. 11 illustrates signals over time t. A carrier signal 40, for example a sinusoidal signal at a frequency between 2 GHz to 8 GHz, for example 6.5 GHz, may be used to generate the transmitted radar pulses T1, T2, e.g., by using a gating or modulating it with an envelope whereas the envelope is generated as a UWB signal pulse with a bandwidth of for example 200 MHz to 500 MHz. The transmitted radar pulse T1 is received as a reflected radar pulse R1 by the TRX-antenna Ant1 of sequence S1, the transmitted radar pulse T2 is received as reflected radar pulse R4 by the TRX-antenna Ant1 in sequence S2.

The reflected radar pulse R1 and the reflected radar pulse R4 are thus coherent in the sense that a comparison and/or combination 41 of the corresponding antenna signals A1 and A4 may be used to determine the spatial information, for example the angle of arrival.

Both transmitted radar pulses T1, T2 have the same starting phase with regard to the carrier signal 40 (here at the null point of the sinus wave, indicated by the dashed lines) and the received reflected radar pulses R1, R4 have a (relative) phase value with regard to the carrier signal 40, as is illustrated by the dashed lines. The multiples of 2π of the phase of the sinus wave of the carrier signal between transmission and reception are not necessary.

Overall, the example shows how a formation of a synthetic antenna aperture for an UWB Radar System can be provided by switching the TRX antenna.

1. A method for operating a radar system, the radar system comprising at least one aperture with a first antenna and a second antenna and a signal source for generating radar pulses and an electronic control circuit, wherein the method comprises:
in a first sequence:
operating the first antenna as a TRX antenna that is connected to the signal source configured to transmit a first radar pulse into surroundings of the radar system, receiving at the first antenna a first reflected radar pulse impinging on the aperture from an external object and generating a first antenna signal from the received first reflected radar pulse,
operating the second antenna as a RX antenna, receiving at the second antenna the first reflected radar pulse and generating a second antenna signal from the received first reflected radar pulse,
in a switching step between the first sequence and a second sequence:
connecting the second antenna to the signal source using a switch of the control circuit, and
in the second sequence:
operating the second antenna as the TRX antenna, transmitting at the second antenna a second radar pulse, receiving a second reflected radar pulse impinging on the aperture from the object and generating a third antenna signal from the received second reflected radar pulse,
operating the first antenna as the RX antenna, receiving at the second antenna the second reflected radar pulse and generating a fourth antenna signal from the received second reflected radar pulse,
at the electronic control circuit:
at least one of combining and comparing at least one of the first antenna signal and the second antenna signal from the first sequence with at least one of the third antenna signal and the fourth antenna signal from the second sequence for generating an analysis signal, and
detecting a spatial information of the object with regard to at least one of the aperture and a coherence information regarding the first radar pulse and the second radar pulse from the analysis signal.

2. The method according to claim 1 further comprising:
calibrating coherence of the signal source with respect to the first radar pulse and the second radar pulse by:
determining a second phase difference value of a phase difference of one of the antenna signals of the first sequence and one of the antenna signals of the second sequence, wherein preferably the second antenna signal and the third antenna signal are used;
determining a phase drift value of a phase drift that the signal source exhibits between the first radar pulse and the second radar pulse, wherein the phase drift value is calculated from a difference between the second phase difference value and a predefined reference value, preferably 0; and
determining a correction value for compensating the phase drift, wherein the correction value is chosen such that considering the corrections value yields the second phase difference value equal to the reference value.

3. The method according to claim 1, wherein the second radar pulse is generated coherent to the first radar pulse by the signal source.

4. The method according to claim 1, wherein detecting the spatial information comprises at least one of
generating a beamforming signal as the analysis signal by delay-and-summing at least one of the first antenna signal and the second antenna signal from the first sequence with at least one of the third antenna signal and the fourth antenna signal from the second sequence, and
determining as the analysis signal a first phase difference of one of the antenna signals of the first sequence and one of the antenna signals of the second sequence, and
determining an angle value from the first phase difference value, the angle value signaling an angle of arrival of the reflected radar pulses that are impinging from the object that reflects the transmitted radar pulses, using geometric data describing a relative geometric arrangement of the first antenna and the second antenna.

5. The method according to claim 1, wherein the determining of the first phase difference value comprises evaluating at least one of a time difference and a phase difference of those antenna signals that are used for determining the first phase difference.

6. The method according to claim 1, wherein a time difference between the first sequence and the second sequence is less than 200 ms.

7. The method according to claim 1, wherein coherency of the signal source is established by at least one of using at least one of a single common clock and oscillator for generating the first radar pulse and the second radar pulse, and by generating the first radar pulse and the second radar pulse as signals that start with identical phases.

8. The method according to claim 1, wherein the respective antenna signal is provided as a channel impulse response.

9. The method according to claim 1, wherein the respective radar pulse is generated using an ultra-wide band signal.

10. The method according to claim 1, wherein at least one additional antenna is provided and for each additional antenna at least one additional sequence is performed in which the respective additional antenna is operated as the TRX antenna and from each additional sequence at least one additional antenna signal is determined that is used for at least one of determining an angle value and beamforming.

11. The method according to claim 10, wherein the first antenna, the second antenna and each additional antenna are arranged in a linear antenna arrangement, preferably an equidistant linear antenna arrangement.

12. The method according to claim 10, wherein the first antenna, the second antenna and each addition antenna are arranged in one of a 2D and a 3D antenna arrangement and the respective analysis signal is calculated based on vector calculation using distance vectors each describing a relative geometric arrangement of two of the antennas in one of 2D and 3D space.

13. The radar system comprising an antenna aperture with at least the first antenna and the second antenna and comprising the signal source for generating radar impulses and comprising the electronic control circuit that is configured to determine a comparison signal using at least one of angle of arrival estimation and beamforming from reflected radar pulses received by the antennas, wherein the signal source is connected to the first antenna and the second antenna over the switch for selectively connecting the signal source at least to the first antenna and the second antenna, and wherein the radar system is configured to perform the steps of claim 1.

14. The radar system according to claim 13 further configured to perform the steps of:
calibrating coherence of the signal source with respect to the first radar pulse and the second radar pulse by:
determining a second phase difference value of a phase difference of one of the antenna signals of the first sequence and one of the antenna signals of the second sequence, wherein preferably the second antenna signal and the third antenna signal are used;
determining a phase drift value of a phase drift that the signal source exhibits between the first radar pulse and the second radar pulse, wherein the phase drift value is calculated from a difference between the second phase difference value and a predefined reference value, preferably 0; and
determining a correction value for compensating the phase drift, wherein the correction value is chosen such that considering the corrections value yields the second phase difference value equal to the reference value.

15. The radar system according to claim 13, wherein the second radar pulse is generated coherent to the first radar pulse by the signal source.

16. The radar system according to claim 13, wherein detecting the spatial information comprises at least one of
generating a beamforming signal as the analysis signal by delay-and-summing at least one of the first antenna signal and the second antenna signal from the first sequence with at least one of the third antenna signal and the fourth antenna signal from the second sequence, and
determining as the analysis signal a first phase difference of one of the antenna signals of the first sequence and one of the antenna signals of the second sequence, and
determining an angle value from the first phase difference value, the angle value signaling an angle of arrival of the reflected radar pulses that are impinging from the object that reflects the transmitted radar pulses, using geometric data describing a relative geometric arrangement of the first antenna and the second antenna.

17. The radar system according to claim 13, wherein the determining of the first phase difference value comprises evaluating at least one of a time difference and a phase difference of those antenna signals that are used for determining the first phase difference.

18. The radar system according to claim 13, wherein a time difference between the first sequence and the second sequence is less than 200 ms.

19. A motor vehicle comprising at least one radar system according to claim 13.

20. The motor vehicle according to claim 19, wherein the at least one radar system is connected to a control device of the vehicle, wherein the control device is configured to
determine a relative position of another traffic object in surrounding traffic by using an angle of arrival determined by the at least one radar system,
distinguish between two traffic objects in the surrounding traffic by using at least two angles of arrival determined by the at least one radar system,
detect a position and/or a movement of a body or of a body part of a person next to the vehicle or inside the vehicle, using at least one angle of arrival determined by the at least one radar system,
a presence of a person on a vehicle seat, using at least one angle of arrival determined by the at least one radar system.
